(19) United States
(12) Patent Application Publication
(10) Pub. No.: US 2013/0278693 A1
(43) Pub. Date: Oct. 24, 2013

(54) SHEET MEDIA CLEANING METHOD AND APPARATUS FOR A PRINTER

(71) Applicant: Theodore Bellisario, Cheltenham (CA)

(72) Inventor: Theodore Bellisario, Cheltenham (CA)

(21) Appl. No.: 13/451,499

(22) Filed: Apr. 19, 2012

(51) Int. Cl. B41J 2/01

(52) U.S. Cl. 347/104

(57) ABSTRACT

Apparatus for cleaning a sheet medium has a cleaning station and a drive mechanism for driving the sheet medium in a transport direction through the cleaning station. The cleaning station has rotary cleaning brushes at opposed surfaces of the sheet medium for brushing the surfaces of the sheet medium to dislodge particulate matter. The brushes are contained in a plenum from which the particulate matter is removed by developing a partial vacuum at the plenum.

### FIELD OF THE INVENTION

This invention relates to a method and apparatus for cleaning sheet media for printing and has particular application for removing particulate material such as paper dust from such media before the sheet media are presented for printing to an inkjet print head.

### BACKGROUND OF THE INVENTION

It is desirable when printing on paper or other sheet materials, whether in the form of cut sheets or roll sheets, to have a printing environment which is as clean and contaminant-free as possible. This is particularly so in the case of inkjet printers where the inkjet nozzles may become partially or fully blocked, thus requiring the periodic use of maintenance equipment and techniques to keep the nozzles functioning efficiently. While the major cause of nozzle blockage is dried ink, another source of particulate material is the sheet media on which printed images are to be formed. Loosely attached particulate material from a paper surface may disrupt ink flow and degrade print quality if allowed to redeposit onto the nozzle area of the inkjet print head. In addition, any of the belt transport, drive rolls and optical sensors may also suffer damage from contamination by paper dust. The particulate matter may be made up of any of paper dust or shavings, coatings or sizing material applied by the paper manufacturer, or may be loose random fibers.

### SUMMARY OF THE INVENTION

According to one aspect of the invention, there is provided apparatus for cleaning a sheet medium at a cleaning station comprising a transport mechanism for driving the sheet medium in a transport direction through the cleaning station, the cleaning station having brushes for brushing opposed surfaces of the sheet medium to dislodge particulate matter from the sheet medium, the brushes housed in a plenum, and a port for applying a partial vacuum at the plenum for removing the dislodged particulate matter.

According to another aspect of the invention, there is provided a method for cleaning a sheet medium comprising driving the sheet medium through the cleaning station and, as the sheet medium is driven through the cleaning station, brushing opposed surfaces of the sheet medium to dislodge particulate matter from the sheet medium, the brushes housed in a plenum, and removing the dislodged particulate matter from the plenum by developing a partial vacuum at the plenum.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a side view of an inkjet printer sheet feed arrangement according to an embodiment of the invention.

FIG. 2 is a top view of the arrangement of FIG. 1.

FIG. 3 is a view to a larger scale of a part of the arrangement of FIG. 1 showing a charge transfer brush and its interaction with paper sheets being fed onto a continuous belt for transport past an array of inkjet print heads.

FIG. 4 is a view to a larger scale of a part of the arrangement of FIG. 1 showing a stripper arrangement for stripping an electrostatically tacked paper sheet from a feed belt after a printing process has been completed.

FIG. 5 is a view of a part of the arrangement of FIG. 1 showing one means for inhibiting image deterioration owing to dust attracted towards print heads by the presence of charge on the belt and paper sheets transported by the belt.

FIG. 6 is a view of a part of the arrangement of FIG. 1 showing another means for inhibiting image deterioration owing to dust attracted towards print heads by the presence of charge on the belt and paper sheets transported by the belt.

FIG. 7 is a side view showing apparatus according to one embodiment of the invention for cleaning a sheet medium to be presented to a printer.

FIGS. 8-10 are views corresponding to FIG. 7 but showing subsequent stages during the cleaning of the sheet medium.

FIG. 11 is a plan view showing apparatus according to an embodiment of the invention for cleaning a sheet medium to be presented to a printer.

FIG. 12 is a plan view showing apparatus according to another embodiment of the invention for cleaning a sheet medium to be presented to a printer.

### DETAILED DESCRIPTION OF THE INVENTION INCLUDING THE PRESENTLY PREFERRED EMBODIMENTS

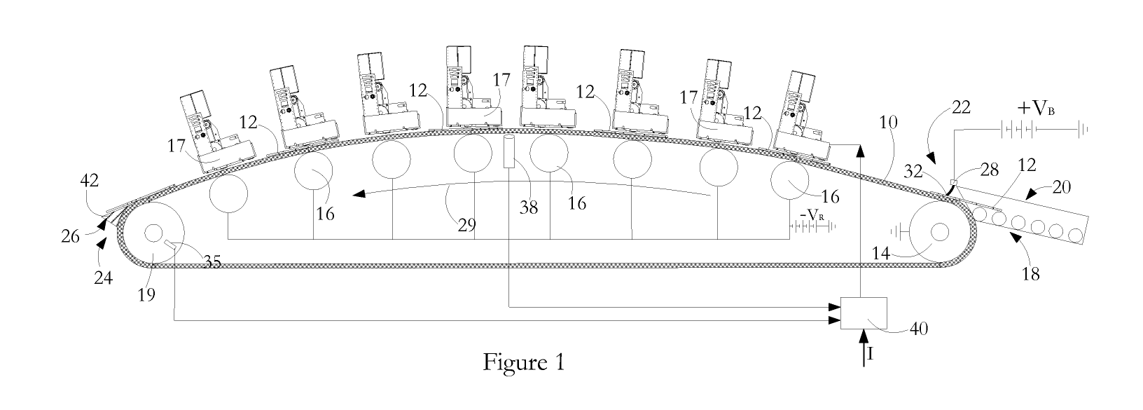

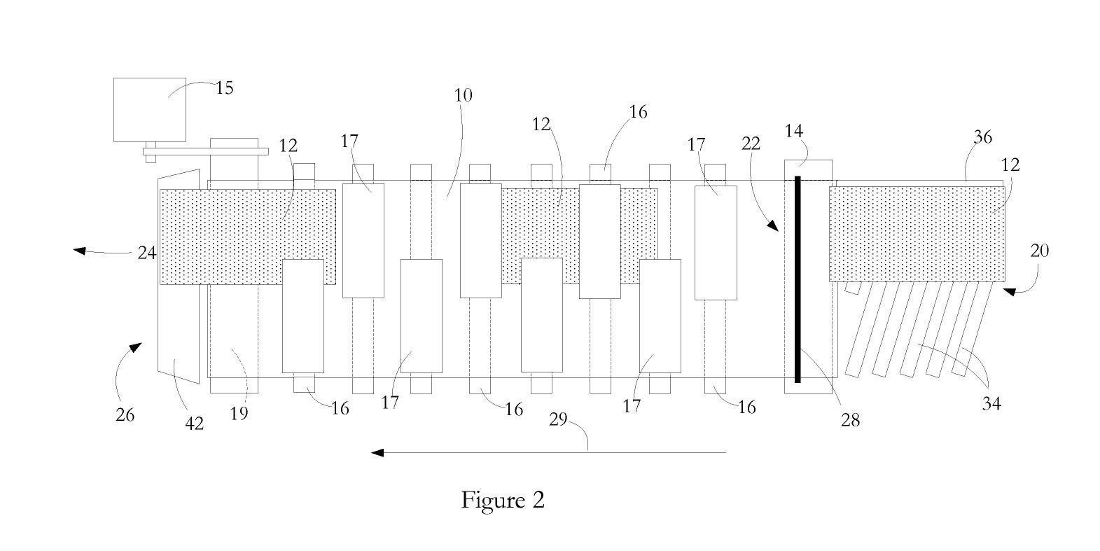

Referring in detail to FIG. 1, there is shown a continuous belt 10 for transporting paper sheets 12, the belt being driven by a drive roller 19 around a series of idler rollers 16. At an input zone, shown generally as 18, there is a paper alignment sub-system 20 and a charge transfer sub-system 22. At an output zone shown generally as 24, is a paper sheet stripper arrangement 26. Each of the idler rollers 16 is located adjacent a corresponding inkjet print engine 17. Each print engine 17 contains an inkjet print head 13 and mechanical, electrical and fluidic hardware needed to position and operate the print head. The belt is made of Mylar®, an electrical insulator having a high dielectric strength, the belt having a thickness of the order of 0.13 millimetres. While other belt materials are envisioned, Mylar® is particularly suitable owing to its strength, stiffness, transparency, dielectric strength and low leakage. As shown in FIGS. 1 and 2, the inkjet print engine array comprises eight print engines arranged in two staggered banks of four print engines. As shown in the side view, the print engines of each bank are arranged in a wide diameter arc with each print engine facing the belt where the belt 10 passes over an associated idler roller 16. The idler rollers 16 are maintained at a negative voltage V_{R} for reasons to be described presently. On the face of each print head 13 are nozzles having exit openings that are spaced from the upper surface of the belt by ½ to 1 millimetre. By tensioning the continuous belt 10 over the arcuate arrangement of rollers 16, the print head to belt spacing is maintained at a comparatively unvarying distance.

As is well-known, inkjet printers operate by ejecting droplets of ink onto a web or sheet medium. Such printers have print heads that are non-contact heads with ink being transferred during the printing process as minute “flying” ink droplets over a short distance of the order of ½ to 1 millimetre. Modern inkjet printers are generally of the continuous type or the drop-on-demand type. In the continuous type, ink is pumped along conduits from ink reservoirs to nozzles. The ink is subjected to vibration to break the ink stream into droplets, with the droplets being charged so that they can be controllably deflected in an applied electric field. In a thermal drop-on-demand type, a small volume of ink is subjected to rapid heating to form a vapour bubble which expels a corresponding droplet of ink. In piezoelectric drop-on-demand printers, a voltage is applied to change the shape of a piezoelectric material and so generate a pressure pulse in the ink and force a droplet from the nozzle. Of particular interest in the context of the present invention are thermal drop-on-demand inkjet print heads commercially available from Silverbrook Research, these being sold under the Memjet trade name which have a very high nozzle density, page wide array and of the order of five channels per print head. Such inkjet print heads have a very high resolution of the order of 1600 dots per inch.

The charge transfer sub-system 22 includes an elongate brush 28 extending transverse to the feed direction. The brush has a series of conducting bristles 30 which are fixed at their upper ends into a conducting housing and which have their lower ends in contact with or close to the upper surface of the paper sheets as they are fed onto the belt 10 at the sheet input zone 18. If the bristles contact paper sheets 12 at the sheet input zone, contact pressure is kept sufficiently low that the sheets are neither damaged nor displaced by the contact. The brush 28 is located close to a grounded conductive roller 14 underlying the belt. The sheets are fed onto the belt by an upstream feed arrangement to be described presently.

In operation, the belt is driven by the roller 19 from a motor 15. The belt tracks around the idler rollers 16 and 14. A potential V_{B} in the range of +1000 volts to +5000 volts is applied to the brush 28. As a paper sheet 12 is transported by the belt past by the brush 28, charge is transferred from bristle tips 32 to the sheet. The sheet is charged positive and a counter negative charge develops on the underside of the belt owing to the presence of the grounded roller 14. The positive charge on the paper sheets 12, in effect, causes the sheets to be electrostatically “tacked” to the belt. While the exact dynamics of charge transfer to the paper sheets 12 are not fully understood, it is believed that there is at least an element of corona discharge around the tips 32 of the bristles where an intense electric field gradient causes ionization of the air with consequent current passing from the brush to the top surface of the belt. This may be compounded by a triboelectric effect in which charge remains on the paper sheets as contact between such sheets and the bristle tips are broken owing to movement of the belt around the roller system. The highly dielectric nature of the material of the Mylar belt means that charge on the paper sheets 12 does not leak away as the sheets are transported from the input zone to the output zone.

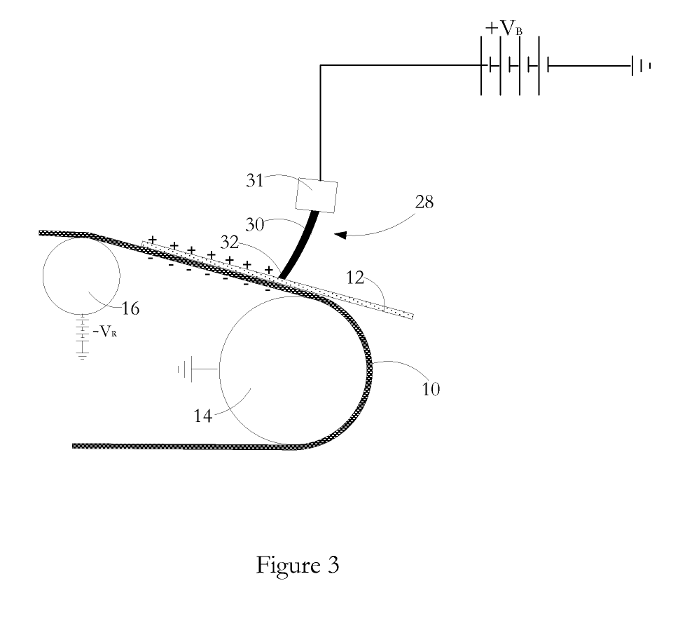

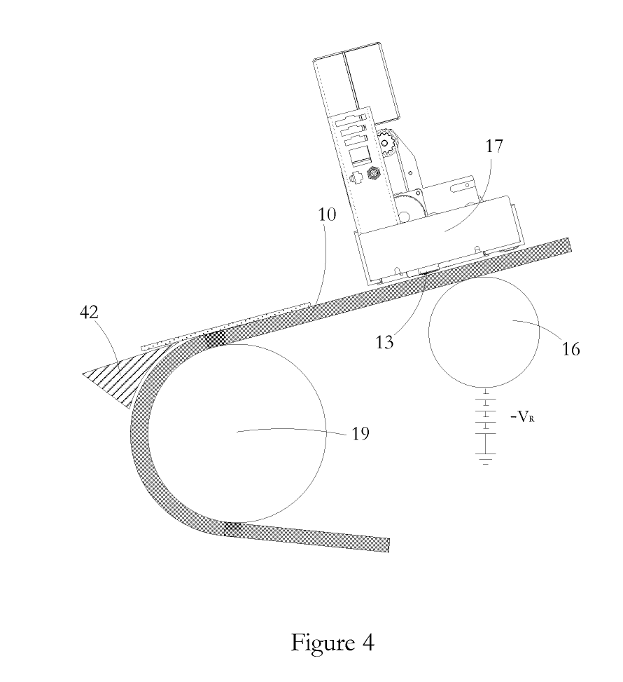

As shown in the scrap view of FIG. 3, the opposite polarity charges—the negative charge at the reverse side of the belt and the positive charge on the paper sheets—set up an attraction which causes the paper sheet to bear against the top surface of the belt. In effect, the paper sheets 12 become electrostatically tacked to the belt.

The paper alignment sub-system 20 is used for initially aligning sheets entering the input zone to a datum and can take any of a number of known forms. The arrangement shown in FIG. 2 has a series of alignment rollers 34 having non-smooth bearing surfaces, the alignment rollers mounted at an angle to the sheet feed direction and a fence 36 aligned with the feed direction. Rectangular paper sheets 12 are transferred into the alignment sub-system generally in an orientation in which they are to pass through the print zones. The inclined rollers 34 are rotated so that a frictional contact between the surfaces of the alignment rollers and the sheets 12 drives the sheets against the fence 36 to more accurately align the sheets with the feed direction. While still under the alignment control of the sub-system 20, leading parts of the sheets pass under the brush 28 and are electrostatically tacked in the then-current position. Other types of feed mechanism for launching sheet media onto the belt may alternatively be used such as a conventional notched wheel driver, the notched wheel having fingers orientated and stiff enough to drive sheets against an alignment edge but sufficiently flexible not to scuff or otherwise damage the sheet media. It will be appreciated that other methods for alignment of sheet media can be used.

The paper alignment sub-system 20 is supplemented by a tracking sub-system which tracks the movement of sheets through the print zone. To ensure accurate positioning of the image on the sheets in the transport direction, the leading edge of each sheet is first detected before the sheet reaches the first print engine in the print engine array. Following this first detection, only the motion of the belt, as accurately measured by a shaft encoder 35 mounted on the belt drive, is used for tracking. Because each sheet is electrostatically tacked to the belt, accurate tracking of the sheets is ensured. Tracking signals from the shaft encoder 35 form inputs to a control module 40, the control module also having an input I comprising the image data for images or partial images to be printed by each of the print engines 17. The control module 40 has outputs (one of which is shown) to each of the print heads which instructs which nozzles of each print head are to be fired and the instant at which each such nozzle is to be fired. The instant of firing of each nozzle is made to depend on the tracking data for that nozzle so that partial images from successive print heads which are to be combined as a single image are in precise registration.

In relation to transverse control, any excursion of the belt in a transverse direction as it is driven through the print zone is monitored by an optical sensor 38 and, based on the sensor output, the idler roller 14 is adjusted to maintain the transverse position of the belt constant to within an acceptably small tolerance. Note that even if accurate initial alignment of sheets is not completely achieved at the sub-system 20 resulting in the sheet having a transverse offset or skew, because the sheet is tacked to the belt, any such offset or skew is unchanged as the sheet is presented to each print engine 17 as it is transported through the print zone. Consequently, component images are subjected to the same offset or skew as they are printed by successive print heads, resulting in an accurately registered combination image.

At the output zone 24, partial stripping of paper sheets 12 from the belt 10 is achieved by using the inherent stiffness of the sheet paper to cause a leading edge portion of a sheet 10 to spring away from the belt 12 as the belt turns through a tight angle at the drive roller 19. Subsequent full stripping of the sheet is achieved by the presence of a stripper bar 42 mounted so that the initially lifted sheet edge portion passes over the top of the bar as the belt passes underneath the bar.

With the invention described, paper sheets are firmly tacked to the belt and so can be accurately transported under the array of inkjet print heads. The multiple print head system can be operated at a very fast sheet processing rate of the order of 140 feet per minute. Even though multiple overprinted or combined images with highly accurate registration can be achieved using this method, ink deposited on a sheet upper surface is not disturbed as the sheet is transported through successive print zones at the array of print heads.

Generally, accurate transport of sheet media is rendered more difficult if the transport system has to handle papers with a wide range of properties. In terms of surface finish, a sheet may be smooth or rough, and shiny or matt. In terms of thickness and density, the paper may range from tissue paper to card stock. The controllability and accuracy of conventional sheet transport systems, including those described previously may vary with variation in any or all of these particular sheet paper properties. The apparatus and method described herein can be used effectively with papers and other sheet media having a range of properties, including surface finish, thickness and density.

By electrostatically tacking the paper to the belt, a simplified tracking system can be used which tracks the position and motion of the belt instead of the position and motion of the paper sheets. The belt material is more stable and stiffer than paper. Consequently, it is easier to obtain accurate registration and other handling dynamics over a wider range of papers regardless of paper surface finish, thickness and density.

A potentially adverse effect of maintaining charge on the upper surface of the belt and the induced charge of opposite polarity on the reverse surface of the belt is that contaminants may be attracted to the print heads from the charged paper sheets. This is unwelcome because the contaminants can cause print head nozzles to become blocked. A two stage removal process is utilized. Firstly, contaminants associated with the paper sheets, such as small particulate paper debris, are removed before the sheets are fed to the belt. Such contaminants may, for example, have been introduced during the paper production process and are distributed on the paper surface. Secondly, predominantly air-borne contaminants such as dust are removed from zones surrounding the print heads and the belt before they can settle in the neighbourhood of the print heads and affect the operation of the print head nozzles.

In one exemplary process for paper cleaning, a tacky or polymer roller is run over the paper sheets with the roller periodically being cleaned to detach any build-up of contaminants from the roller surface. This method is supplemented by the use of antistatic ionization bars to neutralize static electricity and reduce cling of debris to the paper surface. In another sheet cleaning method, loose debris is dislodged by means of a brush rotating counter to the paper feed direction, the dislodged debris being immediately subjected to a vacuum to carry the debris away. This method, too, is supplemented by use of the antistatic ionization bars. In yet another method, paper sheets are pre-cleaned with an air knife.

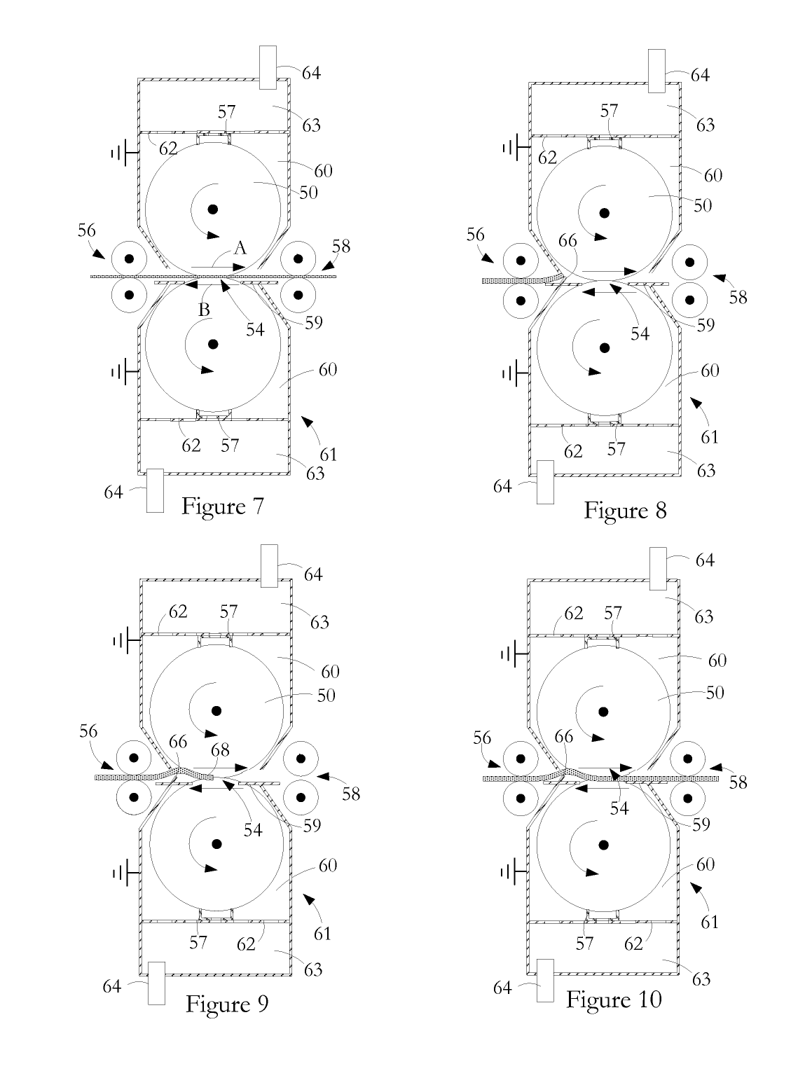

A further apparatus and method for paper cleaning using rotating brushes is illustrated with respect to FIGS. 7 to 10. The apparatus and method are shown in the context of cleaning cut sheets but it will be understood that the method and apparatus are equally applicable to cleaning roll materials. As shown in FIG. 7, the method uses two brushes 50, 52 which define a contact region 54. A paper sheet 12 is thrust into the contact region 54 between the rotating brushes 50 and 52 from upstream roller pair 56 and is drawn from the contact region by a downstream roller pair 58 before being directed to downstream paper transport and print equipment (not shown). This may be one of the forms previously described and illustrated or may be quite a different arrangement. The separation of the roller pair 56 from the roller pair 58 is less than the minimum sheet length in the case of a cut sheet so that before a drive to the paper sheet 12 provided by the nip at roller pair 56 has ended, the paper sheet 12 is being drawn into the nip at the roller pair 58.

The two brushes 50, 52 are rotated so that, at the contact region 54, the bristles of one brush sweep against one surface of the sheet medium in the sheet medium transport direction A, while the bristles of the other brush sweep against the reverse surface of the sheet in a direction B opposite to the transport direction. In the illustrated embodiment of the invention, the top brush has a rotational speed of 700 revolutions per minute and the lower brush has a rotational speed of 230 revolutions per minute. With the brush diameters being of the order of 2.2 inches, the ends of the bottom roller bristles scrape a stationary sheet medium at about 133 feet per minute and the ends of the top roller bristles scrape a stationary sheet medium at about 406 feet per minute. With the sheet medium being forced though the nip by the upstream and downstream mechanism at a speed of about 137 feet per minute, this means that the relative speed of the bristles at the two sheet surfaces is identical at about 270 surface feet per minute. Each brush is mounted so that, in the absence of the other brush, the extreme ends of the bristles would extend of the order of 1 millimetre past the central plane.

Bristles of the brushes are made of nylon, this material being used for its strength, flexibility and abrasion resistance. The bristles have a diameter of the order of 0.07 millimetres and have a thin layer of copper suffused into their surfaces as an anti-static agent. The brushes extend across the full width of the sheet medium 12 being transported through the cleaning station. In operation, the brushes are rotated so that the bristle ends scrape particulates such as paper dust off the sheet surface. The bristle ends are slightly deformed as they pass over the surface of the sheet 12 and spring away from their deformed shape as the brushes 50, 52 rotate further and the bristle ends escape the nip. The bristle ends are subjected to further flicking motions as they pass over walls of a channel member 59 and, in the case of the lower brush 52, as they pass over the edges of tray members 57. The spring movements to which the bristle ends are subjected eject scraped particulate material into an inner chamber 61 of a plenum 60. Each of the brushes 50, 52 is mounted within a respective one of a pair of the chambers 61 which straddle the sheet transport path, the chambers 61 being open at the brush contact region 54. The dislodged particulate material is then sucked out of the inner plenum chamber 61 through a perforated wall 63 to an outer plenum chamber 62 by application of a partial vacuum at ports 64. The plenum structure is electrically grounded so that as the bristles pass over the channel member and the trays, any buildup of static charges is discharged to ground. The trays 57 support the sheets 12 as they approach the brushes 50, 52 on the upstream side and as they exit the contact region 54 on the downstream side.

As shown in FIGS. 7 to 9, a guide member or deflector 66 is used to guide the leading edge 68 of a cut sheet medium 12 into the contact region 54 between the brushes 50, 52. Without the guide member 66, it may be difficult to force the cut sheet 12 into the contact region 54 because the bristle ends push against each other to form a constricting barrier to sheet entry. In addition, as the cut sheet nears the contact region 54, any lateral sweeping force on the transported sheet in the transport direction A from the top brush 50 is essentially balanced by a lateral sweeping force on the sheet in the reverse direction B from the lower roller 52. To encourage the leading edge 68 to breach the constriction, the guide member 66 guides the leading end 68 out of the central plane towards the top brush 50 and away from the bottom brush 52. Consequently, the leading end 68 comes into contact with the top brush 50, so tending to drive the sheet into the contact region 54, rather than the bottom brush 52 which might act against sheet entry. Once the cut sheet leading edge has breached the constricted contact area, further movement past the junction of the brushes is relatively easy. Subsequent stages of movement of the cut sheet as it enters, is driven through, and is drawn from the contact region 54 are illustrated by FIGS. 8 to 10.

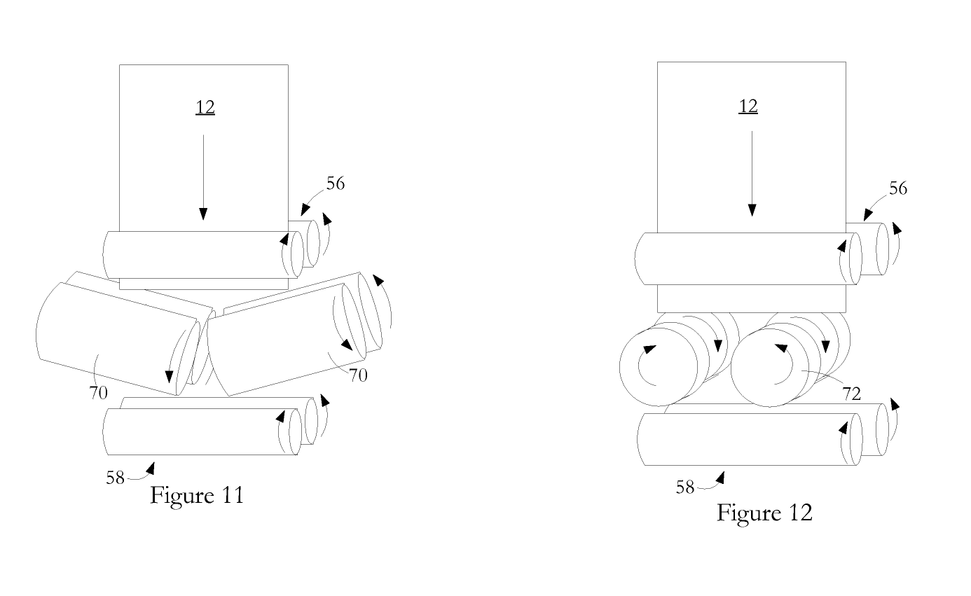

Other brush configurations can be adopted for sweeping the sheet paper surfaces without affecting the sheet transport by ensuring that any force in the transport direction applied to the sheet medium at one surface is substantially balanced by a force in a direction opposite to the transport direction applied at the reverse surface. In the variation shown in FIG. 11, two pairs of brushes 70 are arrayed across the paper width and have their axes of rotation inclined slightly to the transport direction. In this configuration, when cut sheets 12 are being transported, the leading edge 68 of the cut sheet enters the contact region between the brushes progressively starting with the corners of the sheet. This is useful for very thin sheet materials which may have low planar stiffness. In the variation shown in FIG. 12, rotary brushes 72 are illustrated which have their axes of rotation orthogonal to the plane of the paper sheet 12 and with a top brush and the underlying brush rotating in opposite directions. It will be understood that in both these configurations, the cleaning station is contained within a plenum to which a partial vacuum is applied to suck away the dislodged particulate material. It will be appreciated also that while it is convenient to use brush pairs that are dimensionally identical to achieve net zero lateral force on the transported material in the transport direction, brush configurations using non-identical brushes can be used provided that they have the same effect in relation to lateral force on the sheet medium. In addition, while the absence of lateral force in the transport direction is desirable, it is sufficient that any residual force does not unacceptably affect the transport dynamics: for example, the sheet medium movement past the brushes stalls.

It will be appreciated also that the rotary brushes can be substituted by rollers which have a surface material such as a foam, felt or cloth. Such an arrangement will scrape the sheet medium in the same manner as the brush bristle ends. However, a brush is preferred over such napped materials because of the risk with the latter of clogging and the need for the roller members having periodically to be cleaned. In this specification, any and all references to “brushes” and “brushing” are intended to cover the use of materials such as foam, felt or cloth for cleaning the surface of a sheet medium.

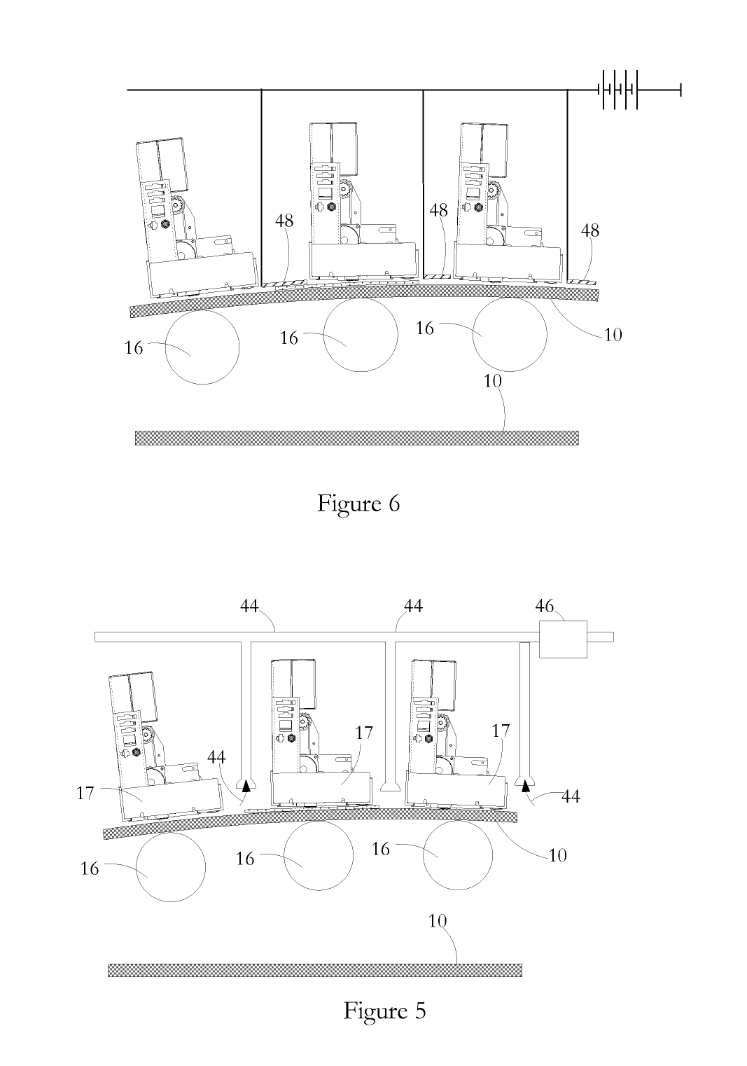

For maintaining a clean zone around the print heads, a first method uses, to the extent possible, features of the clean room environment known, for example, from integrated circuit production. In circumstances where a clean room environment is too expensive or otherwise impractical, other methods are used. In one method, a preventative measure is adopted. As previously mentioned, the rollers 16 underlying the belt 10 are held at a negative potential with a voltage sufficient to bring the associated electric field in the region of the print head nozzles to zero. The negative potential neutralizes the field impact of the charged sheets in the region where the ink droplets exit the nozzles and “fly” to the sheets. In one exemplary dust removal technique illustrated in FIG. 5, precisely directed air currents 44 are generated to sweep air-borne dust particles towards filters which are periodically cleaned or replaced. In another method, as shown in FIG. 6, electrodes 48 are positioned at locations where they do not affect the electric field dynamics required to establish the electrostatic tacking, but where they function to attract the dust particles, the attracted dust being periodically removed from the electrodes. The dust particles that are drawn towards charged electrodes are generally not charged positively or negatively, but exist as dipoles. Consequently, a dust electrode 48 attracts one of the poles of a particle. Once attracted, the dust dipole becomes aligned with the electric field produced by the electrode and so the dust particle as a whole is attracted to the dust electrode.

Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. A method for cleaning a sheet medium comprising driving the sheet medium through a cleaning station and, as the sheet medium is driven through the cleaning station, brushing opposed surfaces of the sheet medium to dislodge particulate matter from the sheet medium, the brushes housed in a plenum, and removing the dislodged particulate matter from the plenum by developing a partial vacuum at the plenum.

2. A method as claimed in claim 1, the brushing of the opposed surfaces introducing substantially no force on the sheet medium in the transport direction.

3. A method as claimed in claim 2, further comprising using a first rotary brush to brush a first surface of the sheet medium and using a second rotary brush to brush the reverse surface of the sheet medium, the brushing of the first surface introducing a force on the sheet medium having at least a component in the transport direction, the brushing of the reverse surface introducing a force on the sheet medium having at least a component in a direction opposite to the transport direction, the component in the opposite direction substantially equalling the component in the transport direction.

4. A method as claimed in claim 3, further comprising using the first and second brushes to brush the respective surfaces of the sheet medium at a mutual coincident contact region.

5. A method as claimed in claim 3, further comprising the first and second rotary brushes having axes of rotation extending transverse to the transport direction.

6. A method as claimed in claim 1, wherein the driving the sheet medium through the cleaning station is effected at first and second roller pairs, each of the roller pairs defining a nip to nip the sheet medium, a first roller pair operable to drive the sheet medium into the cleaning station in the transport direction, the second roller pair operable to draw the sheet medium from the cleaning station in the transport direction.

7. A method as claimed in claim 1, the brushes having bristles with a conducting surface layer, the method further comprising striking the bristles against a grounded member to prevent electrostatic charge build up on the brushes.

8. A method as claimed in claim 3, the brushing by the first brush occurring at a first contact area of the first brush with the sheet medium and tending to drive the sheet medium in the transport direction, the brushing by the second brush occurring at a second contact area of the second brush with the sheet medium and tending to drive the sheet medium in a direction opposite to the transport direction, the method further comprising, in a region immediately upstream of the nip, deflecting the sheet medium away from the second brush and towards the first brush.

9. A method as claimed in claim 8, further comprising, upon a leading edge of the sheet contacting the first brush, the first brush driving the leading edge towards the second brush and towards the contact region.

10. A method as claimed in claim 3, the brushes housed within respective chambers of the plenum, the chambers open at the contact region.

11. Apparatus for cleaning a sheet medium at a cleaning station comprising a transport mechanism for driving the sheet medium in a transport direction through the cleaning station, the cleaning station having brushes for brushing opposed surfaces of the sheet medium to dislodge particulate matter from the sheet medium, the brushes housed in a plenum, and a port for applying a partial vacuum at the plenum for removing the dislodged particulate matter.

12. Apparatus as claimed in 11, the brushes including a first rotary brush for brushing a first surface of the sheet medium and a second rotary brush for brushing the reverse surface of the sheet medium, the first rotary brush operable to apply a brushing force to a first surface of the sheet medium in the transport direction, the second rotary brush operable to apply a brushing force to the reverse surface of the sheet medium in a direction opposite to the transport direction, the brushing force in the transport direction substantially balanced by the brushing force in the opposite direction.

13. Apparatus as claimed in 12, the first and second brushes mounted to apply brushing to respective surfaces of the sheet medium at a mutual coincident contact region.

14. Apparatus as claimed in 12, the first and second brushes having axes of rotation extending transverse to the transport direction.

15. Apparatus as claimed in 11, further comprising the transport mechanism having a first roller pair defining a nip for driving the sheet medium in the transport direction into the cleaning station, and a second roller pair defining a nip for drawing the sheet medium in the transport direction from the cleaning station.

16. Apparatus as claimed in 11, the brushes having bristles with a conducting surface layer, bristles of the brushes positioned to strike a grounding member upon rotation of the brushes.

17. Apparatus as claimed in 12, the first brush rotatable in a direction tending to drive a sheet medium transported though the cleaning station in the transport direction, the second brush rotatable in a direction tending to drive the sheet medium transported though the cleaning station in a direction opposite to the transport direction, and a deflector immediately upstream of the brushes for deflecting a leading edge of the sheet medium during transport thereof away from the second brush and towards the first brush.

18. Apparatus as claimed in 12, the brushes housed within respective chambers of the plenum, the chambers open at a contact region between the brushes.

19. Apparatus as claimed in claim 11, further comprising at least one brush pair having axes of rotation inclined to the transport direction, whereby a rectangular sheet medium transported through the cleaning station in the transport direction enters a contact region between the brushes of the at least one pair progressively starting with a corner of the sheet.

20. Apparatus as claimed in claim 11, at least one pair of brushes having an axis of rotation extending orthogonal to the plane of a sheet transported through the cleaning station in the transport direction, a brush on one side of the plane for brushing one surface of the sheet rotatable in a direction opposite to a brush on the opposite side of the plane for brushing the reverse surface of the sheet.
